(19) United States
(12) Patent Application Publication
(10) Pub. No.: US 2020/0399927 A1
(43) Pub. Date: Dec. 24, 2020

(54) INTERCHANGEABLE CYLINDER FOR LOCKS

(71) Applicant: OJMAR, S.A., ELGOIBAR (Gipuzkoa) (ES)

(72) Inventors: Joseba Jokin AGUIRREZABALA OLASAGASTI, ELGOIBAR (Gipuzkoa) (ES); Ricardo SENDIN MARTIN, ELGOIBAR (Gipuzkoa) (ES); Jon ZABALA ZABALETA, ELGOIBAR (Gipuzkoa) (ES)

(21) Appl. No.: 16/531,636

(22) Filed: Aug. 5, 2019

(30) Foreign Application Priority Data
Aug. 10, 2018 (ES) P201830820

(51) Int. Cl. E05B 1/00; E05B 63/00; E05B 27/00

(52) U.S. Cl. CPC E05B 1/0053; E05B 27/0053; E05B 63/0056

(57) ABSTRACT

Interchangeable cylinder for locks that have an outer cylinder and an inner cylinder that has a locking device that uses a master key to unlock it is provided. The object of the invention is the inner cylinder, which carries an associated wing in functions of a handle, the wing and the body of the cylinder forming a single whole. The wing is integrated in the cylinder itself, and is extended radially beyond its body. The wing is of thin, flat or extra-flat configuration, and is attached to or integrated into the front of the cylinder itself. For application in interchangeable cylinder locks, to comply with ADA regulations.

### CROSS REFERENCE TO RELATED APPLICATION

This Application claims priority of Spanish Patent Application No. P201830820 filed Aug. 10, 2019, which is incorporated herein by reference.

### OBJECT OF THE INVENTION

The object of the invention refers to an interchangeable cylinder for locks, that incorporates in itself a wing that extends with respect to the cylinder body and fulfils functions of opening and closing of the lock, as well as of a handle to pull on it and open the door.

### BACKGROUND OF THE INVENTION

In the current state of the art interchangeable cylinder locks are already known, structured in an outer casing and an inner cylinder, in which, the inner cylinder being in an intermediate position between closing position and opening position with respect to the outer casing, the inner cylinder can be changed using a locking device. Solutions used to unlock the mentioned locking device can be diverse: in, for example and among others the documents CN106948660, JP2006132107, ES1002268 and ES1035985 (of the same applicant) some of them are described.

### Technical Problem to be Resolved

Interchangeable cylinders of known locks do not comply with the regulation for persons with disabilities (hereinafter ADA regulation, for its acronym in English).

To comply with this ADA regulation, known locks incorporate in the knob a wing, which fulfils functions of a handle. The knob is one of the components of the lock; therefore, currently it is necessary to use different locks if compliance with ADA regulation is required or not; and this problem occurs whether or not the locks are interchangeable cylinder type.

### SUMMARY OF THE INVENTION

The object of the invention solves this problem. It refers to an interchangeable cylinder for locks that is comprised of an outer cylinder and an inner cylinder, the inner cylinder being interchangeable without affecting other components of the lock.

The interchangeable cylinder which is the object of the invention is the interior cylinder. According to the invention, being of the type that use a master key to unlock it, it is characterized in that said cylinder body carries in itself associated or integrated a wing that is extended radially beyond the cylinder body, in functions of a handle.

This wing is of thin, flat or extra-flat configuration, and is attached to or integrated into the front of the interchangeable cylinder.

From this basic structure, any embodiments that do not essentially alter, change or modify the proposal are included in the object of the invention.

In any case, according to the invention, the cylinder itself has the handle, causing the lock in which it is placed to comply with ADA regulation without involving any alteration in remaining components of the lock; thus, it is possible that the same lock may or may not comply with ADA regulation (it will comply with it by simply using the interchangeable cylinder that is the object of the invention).

Other configurations and advantages of the invention can be deduced from the following description, and from the dependent claims.

### BRIEF DESCRIPTION OF THE DRAWINGS

To better understand the object of the invention, a preferential form of embodiment, subject to accessory changes which do not essentially alter it, is represented in the attached figures. In this case:

FIG. 1 represents a schematic view in perspective of the outer cylinder (1) and of the inner cylinder (2) of an interchangeable cylinder lock in assembly arrangement. The object of the invention is the interchangeable inner cylinder. (2).

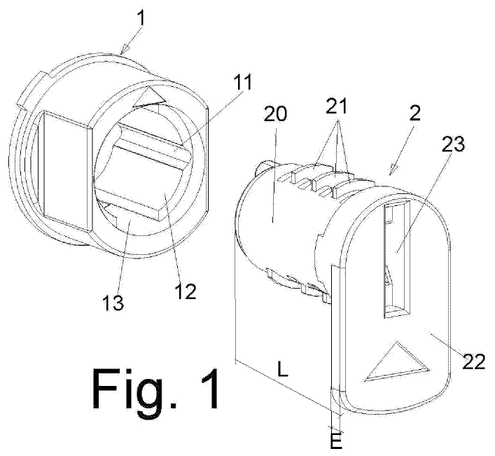

FIG. 2 represents a schematic view in perspective similar to the foregoing figure, with the components of the lock assembled, to observe the operational arrangement of the wing (22) integrated into the interchangeable cylinder (2).

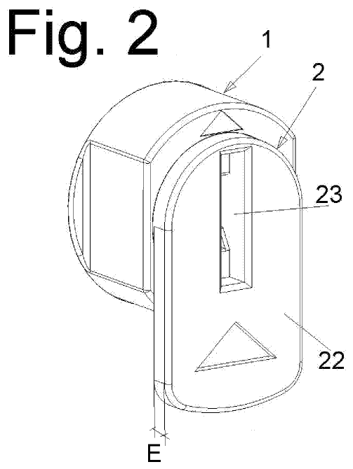

### DETAILED DESCRIPTION OF THE INVENTION

The following describes an example of practical, non-limiting embodiment of this invention. Other modes of embodiment in which accessory changes which do not essentially change it are introduced are in no way disregarded.

The object of the invention is an interchangeable cylinder for locks of the type that are comprised of an outer cylinder (1) and an inner cylinder (2); where the inner cylinder (2) carries a system of pins (21) actuated by keys inserted in a central groove (13). Through this central groove (13) the different keys (not represented) act on the system of pins (21). The object of the invention is the interchangeable cylinder. (2).

According to the embodiment represented:
the outer cylinder (1) is hollow, with arches (12) that thicken its interior, leaving between them empty zones (13). In at least one of said arches (12) a longitudinal rail has been made (11) according to its generator. The bottom of said arches (12) finishes in a circumferential rail (14);
the inner cylinder (2) is installed inside the outer cylinder (1) with possibility of turning: the inner cylinder (2) turns from a conventional key or a special/master key inserted in a system of pins (21), to the position and opening or of closing, only with the special/master key is it allowed to release the locking device for removal of the inner cylinder (2)

According to the invention, and according to the embodiment represented, the interchangeable cylinder (2) carries associated a wing (22), in functions of opening and closing of the lock, as well as of the handle in order to pull on it and open the door.

This wing (22) is attached or integrated forming a single whole with the cylinder (2) from which it extends radially beyond its body. (20).

This wing (22) is of thin, flat or extra-flat configuration of thickness (E), and is attached or integrated into the front of the interchangeable cylinder (2).

The wing (22) is contained on a plane parallel to the one that contains the front of the cylinder (2), increasing total length (L) of the cylinder (2) with respect to total length of a standard cylinder in the same extent of the thickness (E) of the wing (22) that constitutes the handle.

With this structure and these particularities, the same interchangeable cylinder lock complies with ADA regulation if it assembles the cylinder (2) that is object of the invention, or does not comply with it if a standard cylinder is assembled.

The materials, dimensions, proportions and, in general, those other accessory or secondary details that do not essentially alter, change or modify the proposal may vary.

The terms in which this report is written are a true and faithful reflection of the object described, and must be taken in their broadest sense and never in a limiting manner.

1. Interchangeable cylinder for locks comprising an outer cylinder and an inner cylinder that has a locking device that uses a master key to unlock it; wherein the inner interchangeable cylinder carries associated a wing in functions of opening and closing of the lock as well as of handle in order to pull on it and open the door, the wing and the body of the cylinder forming a single whole.

2. Interchangeable cylinder for locks, according to claim 1, wherein the wing is integrated into the cylinder, and is extended radially beyond its body.

3. Interchangeable cylinder for locks, according to claim 1, wherein the wing is of thin, flat or extra-flat configuration and is attached to or integrated into the front of the cylinder.
